(19) United States
(12) Patent Application Publication
(10) Pub. No.: US 2005/0243246 A1
(43) Pub. Date: Nov. 3, 2005

(54) Active matrix liquid crystal display devices with feedback control of drive signals

(76) Inventors: Martin J. Edwards, Crawley (GB); Roger Pook, East Grinstead (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/526,592

(22) PCT Filed: Aug. 22, 2003
(86) PCT No.: PCT/IB03/03925

§ 371 Date: Mar. 2, 2005

(30) Foreign Application Priority Data
Sep. 5, 2002 (GB) 02206175

(51) Int. Cl. G02F 1/1335

(52) U.S. Cl. 349/98

(57) ABSTRACT

An active matrix liquid crystal (LC) display device, comprising in a display area (25) an array of picture elements (12) each having a picture element electrode (15) which together with an opposing common electrode (24) defines an LC display element (21) and a storage capacitor (20) connected to the picture element electrode, includes adjustment means (40,34) for adjusting drive signals applied by a drive circuit (35) to the picture elements (12) in accordance with changes in the LC capacitance. The adjustment means comprises an oscillator circuit (40) which is coupled to at least some of the picture elements in the array and whose oscillation frequency is determined by a capacitance associated with those picture elements and dependent on the capacitances of their LC display elements. The oscillator circuit may be coupled, via switch means (50,61,72), to a storage capacitor line (22) interconnecting the storage capacitor (20) of the picture elements (12) or to the common electrode (24). The oscillator circuit may be integrated on a substrate of the device, together with the picture element drive circuitry (35).

This invention relates to active matrix liquid crystal display devices (AMLCDs) and more particularly to AMLCDs having in a display area an array of picture elements operable to produce a display image, each picture element comprising a picture element electrode, which together with an opposing, common, electrode defines a liquid crystal display element, and a storage capacitor connected to the picture element electrode, and including adjustment means for adjusting drive signals applied to the picture elements in accordance with changes in the liquid crystal capacitance.

Techniques for automatically controlling display drive parameters, for example, the DC bias appearing across the display elements in an AMLCD, are known. However, such techniques are often complicated and difficult to implement. In order to provide automatically adjustments to the drive signals using a feedback type control circuit it is necessary to identify a way of determining how the liquid crystal (LC) material is affected by the drive voltages applied to it. A preferable characteristic in this respect is the capacitance of the LC material. The capacitance of the LC layer is related to the orientation of the LC molecules and therefore is closely related to the optical behaviour of the LC display elements.

W001/91427 describes an LC display device in which pairs of interconnected dummy LC display elements located outside the display area are driven in a particular way, shorted together and the resulting voltage measured with a sense amplifier, this voltage being an indication of response time or the clearing temperature of the LC material. However, these techniques normally require the use of analogue circuitry and therefore are unsuitable in, for example, display devices having integrated drive circuitry fabricated using the same thin film technology as for the picture element array, such as poly-Si AMLCDs using polycrystalline silicon type thin film transistors (TFTs) as switching devices in the picture elements. For such purposes, it would be desirable to use a technique which can be implemented using simple circuitry that can easily be integrated onto a substrate of the display device using TFTs, thereby minimising the external circuitry required to operate the display and avoiding the need to adjust individually the drive conditions of each display.

It has also been proposed in WO 01/91427 to use in an AMLCD for the purpose of sensing the clearing point of the LC material a single dummy LC display element located outside the area of the picture element array which is connected to an oscillator circuit and whose capacitance is one of the parameters that determines the frequency of oscillation. This approach may be acceptable for sensing simply the clearing point, but is unsuitable for measuring other operational characteristics of the device, particularly those associated with the behaviour of the actual display elements, for example the response of the LC material to applied voltage or temperature changes. For this the dummy display element would need to be truly representative of the actual display elements in all aspects of their behaviour, which would be difficult to achieve in practice. Amongst other things, the effect of stray capacitance of the measurement circuit, or the connections to it, on the operation of the single dummy display element would probably make it impossible to use the dummy display element for such measurement purposes.

According to the present invention, there is provided an AMLCD as described in the opening paragraph, wherein the adjustment means comprises an oscillator circuit which is coupled to a plurality of picture elements in the array and whose frequency of oscillation provides a measure of a capacitance associated with the plurality of picture elements and dependent on the capacitance of their LC display elements.

The invention results in significant advantages. Because the adjustment means uses actual picture elements in the display area, the difficulty of creating dummy display elements that are truly representative of the actual display elements in all aspects of their behaviour is avoided. The measurement will take into account different drive conditions experienced by the display elements over time, for example resulting from different video images being displayed over prolonged periods, without necessarily requiring the generation of any special drive signals. Moreover, the result of the measurement performed by the adjustment means would be representative of the average drive conditions experienced by the LC display elements of the picture elements used taking into account variations over the area of the picture element array, for example in alignments or dielectric layer thicknesses, and consequential non-uniformities.

Further, because the adjustment means measures a capacitance to which a plurality of picture elements contribute, rather than the capacitance of a single display element, the effect of stray capacitance of the adjustment means, or connections to it, is avoided or at least considerably reduced. Importantly, unlike the approach used in the earlier proposal, the invention does not rely on the direct measurement of an individual LC display element capacitance. Further, the technique used in the invention is entirely compatible with utilising picture elements in the array and does not require, for example, picture element electrodes to be connected together in a particular fashion. In this respect, the adjustment means is preferably arranged to measure the capacitance associated with either the common electrode or the storage capacitors of the plurality of picture elements, in the latter case preferably via the storage capacitor line(s) conventionally used to connect the storage capacitors of a row of picture elements together. It will be appreciated that the capacitances of the storage capacitors and common electrode depend on the LC display element capacitances, and therefore can provide an indirect means of determining the capacitance, and hence the state, of the LC display elements without requiring a special display element lay-out.

By using in the adjustment means an oscillator circuit in which the capacitance measured determines (at least in part) the frequency of oscillation provision of the adjustment means is simplified. Such an oscillator circuit can be readily implemented using simple circuitry, for example with CMOS logic gates, and easily integrated onto the active substrate of the device using thin film circuit components comprising TFTs, for example poly-Si TFTs, thereby minimising the external circuitry required and avoiding the need to individually adjust the drive conditions of each display device. The frequency of oscillation of the circuit provides a measure of the response of the LC to factors such as applied voltages and ambient temperature. The output signal from the circuit, indicative of the frequency, can readily be used to implement automatic adjustment of one or more of the parameters of the drive waveforms employed.

In order to avoid, or at least minimise, disturbance to the display image produced by the picture elements, for example as a result of the performance of a measuring operation possibly affecting the voltage waveforms appearing across the LC, then the measurement by the adjustment means may be applied to all the picture elements in the array, either simultaneously or in groups. Accordingly, this will avoid banding or blocking effects in the display image which may otherwise be apparent if, for example, only a few rows of picture elements were to be used for measurement purposes.

Switch means is preferably included which is selectively operable to switch the common electrode or storage capacitor connection line between a potential source and the oscillator circuit.

Any possible disturbance of the display elements voltage is likely to occur only while a measurement is being made. The time required to perform a measurement can be made very small in comparison with the frame period so that display element disturbance will have only a very small effect on the rms voltage or average voltage appearing across the display elements.

Embodiments of AMLCDs in accordance with the present invention will now be described, by way of example, with reference to the accompanying drawings, in which:

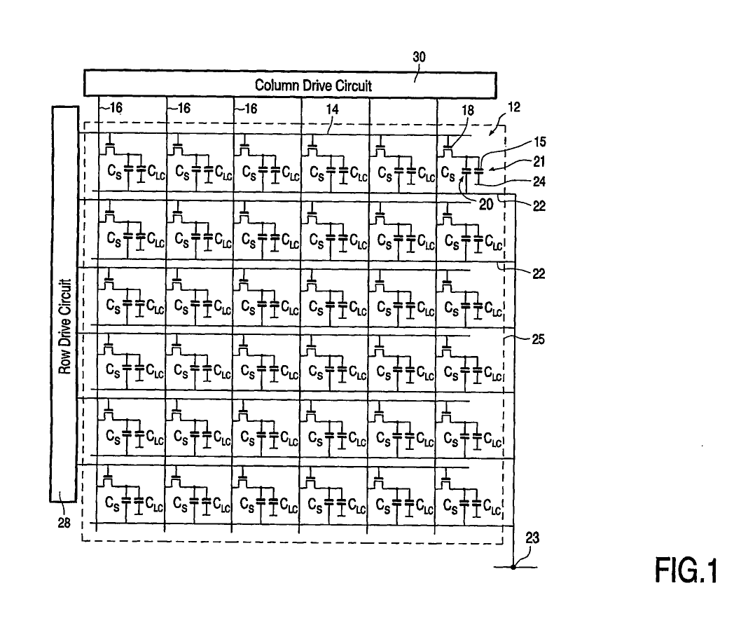

FIG. 1 shows the equivalent circuit of a conventional AMLCD;

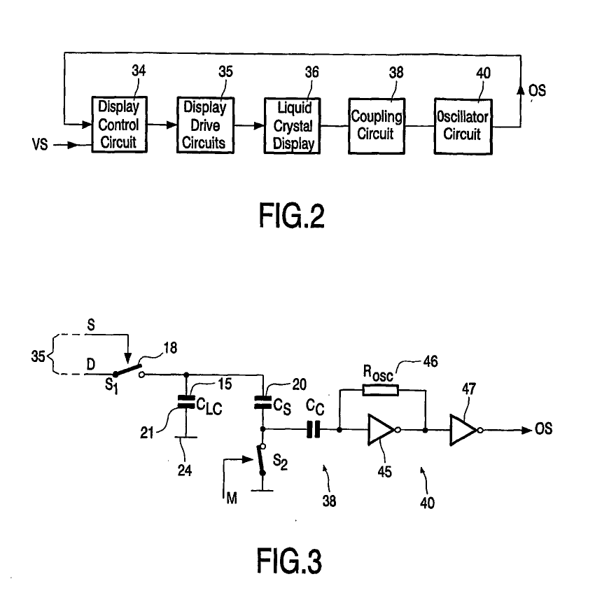

FIG. 2 illustrates in block diagram the operating principle of an AMLCD in accordance with the invention;

FIG. 3 shows schematically an example circuit employed in adjustment means used in an AMLCD according to the invention;

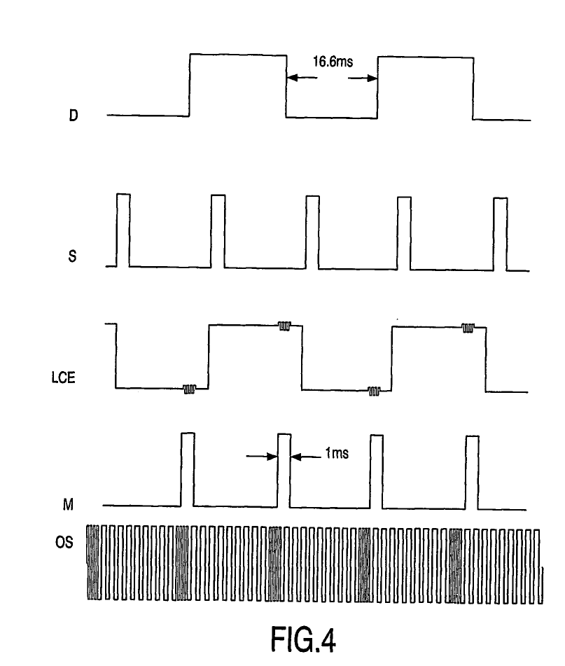

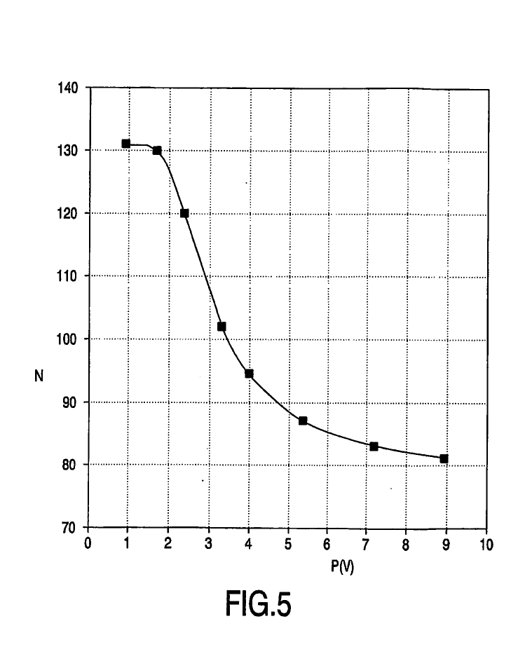

FIG. 4 illustrates example waveforms present in operation of the circuit of FIG. 3;

FIG. 5 is a graph illustrating the relationship between certain drive voltages and the output of the circuit of FIG. 3;

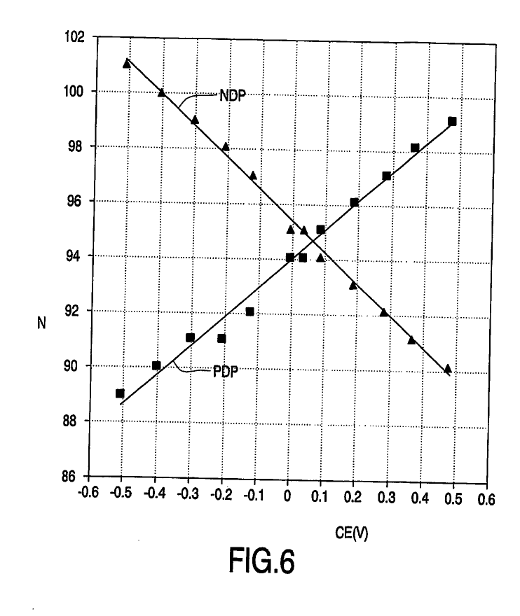

FIG. 6 is a graph illustrating the relationship between a common electrode voltage of AMLCD and the output of the circuit of FIG. 3;

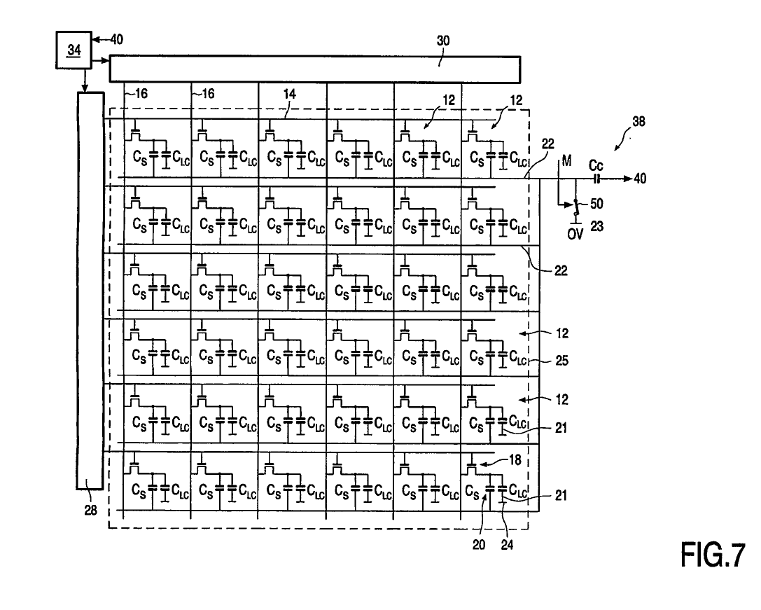

FIG. 7 shows the equivalent circuit of a first embodiment of AMLCD according to the present invention;

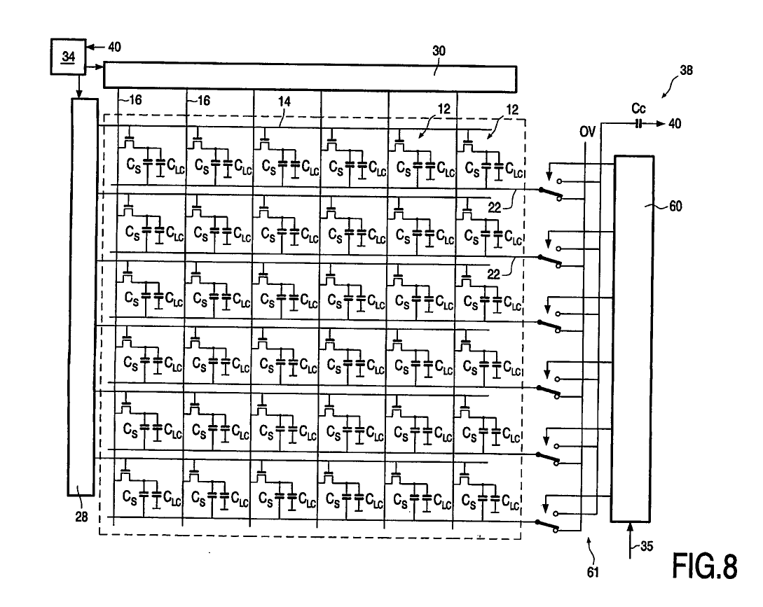

FIG. 8 illustrates an alternative arrangement in the AMLCD of FIG. 7; and

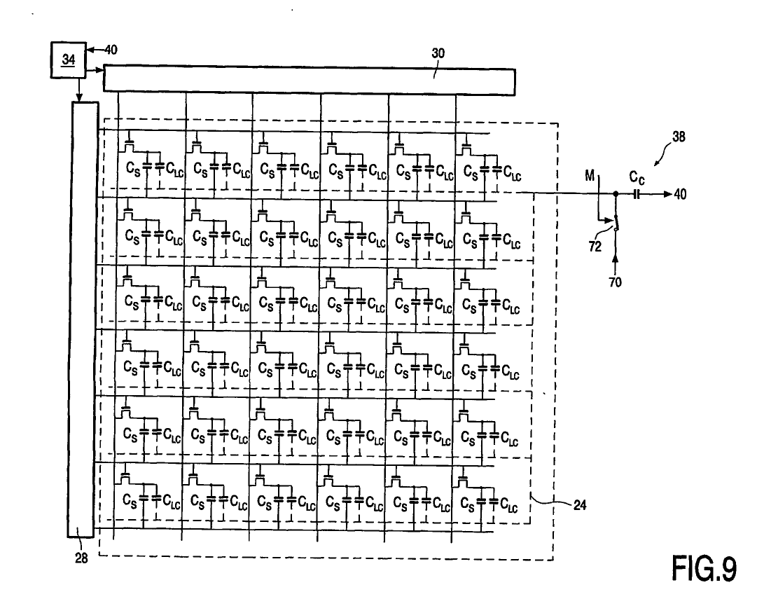

FIG. 9 shows the equivalent circuit of a second embodiment of AMLCD in accordance with the present invention.

It will be appreciated that the figures are all schematic. The same reference numbers and symbols are used throughout the figures to denote the same or similar parts or features.

Various embodiments of AMLCDs in accordance with the invention will be described. The construction and general operation of these devices follow conventional practice and will not be described here in detail. For further information in these respects reference is invited, for example, to US-A-5130829 which describes the basic operational and constructional principles of an AMLCD.

The circuit configuration of a typical AMLCD is shown schematically in FIG. 1. The device comprises a row and column matrix array of picture elements 12 located at respective intersections between crossing sets of row and column address conductors 14 and 16. Each picture element has a TFT (thin film transistor) 18 whose drain electrode is connected to a picture element electrode 15 and whose gate and source electrodes are connected to a row conductor 14 and column conductor 16 respectively. The gates of the TFTs in a row of picture elements 12 are connected to the same row conductor 14 while the source electrodes of all TFTs in a column of picture elements are connected to the same column conductor 16. Each picture element 12 further includes a storage capacitor 20 connected between the picture element electrode 15 and a respective capacitor line 22 shared by a row of picture elements. The capacitor lines 22 for all rows in the array are connected at their ends to a predetermined reference potential source 23, for example, ground. The conductors 14 and 16, TFTs 18, picture element electrodes 15, storage capacitors 20 and lines 22 are all carried on an insulating first substrate (not shown), for example of glass. A second substrate, for example also of glass, spaced form the first substrate carries an electrode layer 24, typically of ITO, common to all picture elements 12 in the array. LC material is disposed between the two substrates and each picture element electrode 15 together with the immediately overlying portion of the common electrode 24 and the LC material sandwiched therebetween constitutes an LC display element 21. The two substrates together with the LC material sealed inbetween form an LC cell structure.

The array of picture elements 12 defines a display area 25 (here the area denoted by a dotted line) in which a display image is produced in operation. The rows of picture elements 12 are addressed one at a time in sequence by means of a row drive circuit 28 which applies to each row conductor 14 in turn a selection (gating) signal in a respective row address period which turns on the TFTs 18 of the row. A column drive circuit 30 applies data signals to the column conductors 16, obtained by sampling an input video signal, in synchronism with row addressing such that the picture element electrodes 15 in a selected row are charged, via the TFTs, according to the level of the voltage of the data signals on the respective column conductors 16. The drive voltage applied to a picture element electrode 15 determines a desired display effect with the light transmission through the display element 21 being modulated according to the level of the applied drive voltage to produce a display output ranging from fully on (white) to fully off (black) through intermediate grey-scale levels. At the end of the row address period, following termination of the selection signal, the TFTs of the row are turned off to isolate the electrodes 15 and the applied voltage is stored on the display element capacitances and their associated storage capacitors 20 until they are addressed again, usually in the next frame period. Each row of picture elements is addressed in turn so as to build up a complete display picture over one frame and the array of picture elements repeatedly addressed in this manner in subsequent frame periods.

In each of the AMLCD embodiments to be described adjustment means in the form of a feedback control circuit is used to provide automatic adjustment of, for example, the picture element drive waveforms for various purposes, as will be explained. To this end the capacitance of the LC layer at the display elements of the device is utilised as a means of determining the effect on the LC of applied drive waveforms, e.g. voltages and timings, the LC capacitance being related to the orientation of the LC molecules, and thus closely related to the optical behaviour of the LC display elements. In these embodiments an oscillator circuit is employed in the adjustment means and the capacitance of the LC provides one of the parameters which determines the frequency of oscillation. This frequency therefore provides a measure of the response of the LC to factors such as applied voltage and temperature.

To obtain the LC capacitance, a group of picture elements, a number of groups of picture elements, or all the picture elements in the picture element array may be utilised so as to provide an average capacitance measurement.

The general scheme of the operation of the embodiments of AMLCD with the adjustment means is shown in the block diagram of FIG. 2, in which the block 35 represents the array drive circuit, which includes the row and column driver circuits 28 and 30, the block 36 represents the array of picture elements 12. The drive circuit 35 is arranged to produce required LC drive voltage waveforms across the LC display elements. These waveforms may typically be similar to those used conventionally.

A display control circuit, 34, provides the necessary timing and control signals for the array drive circuit 35 and also the video signal VS supplied to the circuit 34 from an external video source and from which the data signals for the picture elements are derived. Picture elements in the array are connected to the oscillator circuit, here denoted by the block 40 through a coupling circuit 38. The function of the circuit 38 is to couple the capacitance of the LC display elements 21 of the picture elements 12 to the input of the oscillator circuit 40 so that the frequency of oscillation depends on the display element capacitance whilst limiting the extent to which the operation of the circuit 40 might affect the voltages across the display elements 21 and also limiting the direct effect that the drive waveforms applied to the display elements have on the operation of the circuit 40. The drive waveforms will, of course, affect the frequency of oscillation indirectly by way of changing the capacitance of the LC display elements.

FIG. 3 shows schematically an example implementation of the coupling and oscillator circuitry in more detail. For simplicity, here only one LC display element 12 is shown although in practice a plurality of display elements would be used. The liquid crystal drive circuit 35 includes a source of an alternating voltage waveform D (e.g. the LC data signal drive waveform from the column drive circuit 30) and a switch S₁, comprising a TFT 18, which allows the LC display element to be periodically charged, (according to a switching signal S controlling the switch S₁) to the level of the LC drive waveform D. Connected in parallel with the capacitance of the LC display element, C_{LC}, is the storage capacitor 20 with capacitance C_{S}. The second terminal of the storage capacitor is connected to ground via a switch, S₂. The input of the oscillator circuit 40 is coupled to the display element 21 by the series connected capacitors C_{C} and C_{S}. The oscillator is formed using a CMOS inverter 45 with a resistor 46, R_{OSC}, providing feedback from the output of the inverter to the input. The output of the oscillator is buffered by a second inverter 47. When the switch S₂ is closed the capacitance at the input of the oscillator is approximately equal to C_{C}. When a measurement indicative of the capacitance of the LC display element 21 is to be made switch S₂ is opened. The capacitance at the input of the oscillator is then approximately (1/C_{LC}+1/C_{S}+1/C_{C})⁻¹. The frequency of oscillation of the circuit therefore depends on the value of C_{LC}.

Waveforms which illustrate how this circuit might be operated are shown in FIG. 4. The LC display element drive signal waveform D consists of a frame inversion data signal voltage waveform which changes polarity every 16.6 ms (for a VGA display). The select waveform, S, causes the switch S₁ to close once in every 16.6 ms period which results in charging of the storage capacitor 20 and the LC display element 21 capacitance to the LC drive signal voltage. LCE is the voltage across the LC display element 21. When the capacitance of the display element 21 is to be measured the measurement enable waveform M applied to the switch S₂ goes high causing switch S₂ to open. The duration of the measurement enable pulse in this example is set at 1 ms. The oscillator operates continuously and when the measurement enable signal is low the frequency of oscillation depends principally on the value of the capacitance C_{C}. When the measurement enable signal is high the frequency of oscillation depends on the value of the series combination of C_{LC}, C_{S} and C_{C}, that is (1/C_{LC}+1/C_{S}+1/C_{C})⁻¹. The oscillator circuit output waveform, comprising a succession of output clock pulses, is shown at OS. This signal is fed back to the display control circuit 34 where it can be used to provide adjustments to drive waveforms for various different purposes. During the measurement process a small signal will be coupled from the input of the oscillator circuit onto the LC display element 21. However this will have relatively little effect on the behaviour of the liquid crystal because of its low amplitude and relatively short duration. A measure of the capacitance of the LC display element 21 can be obtained by counting the number of cycles of the oscillator output during the 1 ms period when the measurement is enabled. The oscillator frequency provides an instantaneous measurement of the capacitance of the LC display element 21. In this example, the measurement is enabled (M) some time after the change in the polarity of the drive voltage applied to the liquid crystal in order to allow for the response time of the liquid crystal molecules.

FIG. 5 shows measured results illustrating the way the number, N, of oscillator clock periods during the measurement period of 1ms varies with the peak to peak drive voltage, P, applied to the LC display elements by the liquid crystal drive circuit 35. When the drive voltage is low the capacitance of the LC element is relatively low and therefore the frequency of oscillation and the count of the oscillator clock periods is relatively high. As the drive voltage is increased the liquid crystal molecules start to react to the applied voltage by changing their orientation which results in an increase of the capacitance of the LC element. This causes the capacitance at the input of the oscillator to increase which in turn causes the oscillator frequency and the count of oscillator clock periods to fall. As the drive voltage is increased further the movement of the liquid crystal molecules start to saturate so that the capacitance of the LC element tends towards a maximum value and the oscillator clock frequency tends towards a minimum value.

The variation of oscillator frequency with drive voltage which is shown in FIG. 5 gives an indication of the response of the liquid crystal to the applied peak to peak drive voltage and can therefore be used in the display control circuit 34 to provide automatic adjustment of the drive voltage waveforms of the display device. For example, changes in the behaviour of the liquid crystal as the ambient temperature of the display varied can be detected using this technique. This might involve determining the threshold voltage of the liquid crystal by detecting the drive voltage at which the capacitance of the liquid crystal starts to increase from its minimum value (the point at which the oscillator frequency starts to fall from its maximum value). Knowledge of the threshold voltage of the liquid crystal could then be used to determine the drive voltages required by the display device. In a more advanced scheme the measured capacitance versus drive voltage behaviour of the liquid crystal might be used to determine the gamma correction applied to the display device. This might be carried out by using the capacitance information to generate data for a look up table or by using it to select one of a number of predetermined gamma functions.

Another aspect of establishing the correct drive voltages for a liquid crystal display device is minimising the dc voltage across the liquid crystal. If the dc voltage applied to the LC display elements 21 is not set correctly then problems such as low frequency flicker and image sticking can occur. By comparing the capacitance of the LC display element resulting from positive and negative drive voltages it is possible to determine when the dc voltage across the liquid crystal is correctly adjusted. FIG. 6 shows the effect that varying the dc voltage applied to the common electrode 24 of the LC display element 2 has on the oscillator frequency during periods when the LC element receives positive and negative drive voltages. In this Figure, CE is the common electrode voltage, N is, again, the number of oscillator clock periods in 1 ms, and NDP and PDP are respectively the negative drive period and the positive drive period.

When the common electrode potential is correctly adjusted the voltage across the liquid crystal is equal in magnitude but opposite in polarity during positive and negative drive periods. Therefore the capacitance of the LC display element 21 and the frequency of the oscillator will be the same for the positive and negative drive periods. When the dc voltage on the common electrode 24 is made more negative than its optimum value the voltage across the liquid crystal is increased during the positive drive periods and decreased during the negative drive periods. As a result, the capacitance of the liquid crystal is increased during the positive drive period and decreased during the negative drive period. This is reflected in the decreased oscillator frequency during the positive drive period and the increased frequency during the negative drive period which can be seen in FIG. 6. When the common electrode potential is made more positive than its optimum value the changes are reversed.

There is an increase in the oscillator frequency during the positive drive period (PDP) and a decrease in the frequency during the negative (NDP) drive period. Using the output signal OS, therefore, the dc voltage appearing across the LC display element can accordingly be minimised by adjusting the dc potential of the common electrode 24 until the difference between the oscillator frequencies in positive and negative drive periods is minimised.

Referring again to FIG. 2, the output from the oscillator circuit 40 is fed back to the display control circuit 34. This circuit applies drive signals to the picture element array via the drive circuit 35 and measures this response by determining the output frequency of the oscillator circuit 40. The circuit 34 controls the characteristics of the drive signals applied to the array and uses the information obtained from the measurement of the LC display elements'capacitance to ensure that the applied drive waveforms are correctly adjusted. Suitable circuits for modifying or adjusting the drive signals for the purposes described previously will be apparent to persons skilled in the art.

The oscillator circuit 40 may be used to measure the capacitance of the liquid crystal in a number of ways. For example, it might be operated continuously so that the frequency of oscillation provides an indication of the way in which the capacitance of the liquid crystal cell structure varies with time. Alternatively, the oscillator circuit might be operated at specific times, effectively sampling the value of the liquid crystal capacitance. The drive voltage applied to the liquid crystal might be stepped through a number of values and the capacitance measured for each value in order to characterise the response of the liquid crystal to drive voltage. Other characteristics of the drive signals might be varied and the response of the liquid crystal measured, for example the response to a change in drive frequency or addressing frequency might be measured.

Example embodiments of AMLCDs in accordance with the present invention using the above described type of adjustment means will now be described. In these embodiments, all the LC display elements 21 in the display area array are utilised by the adjustment means. The possibility of unwanted display artefacts which could occur when using only selected display elements for this purpose is then avoided. However, only some of the display elements may be utilised if desired. In these embodiments, the oscillator circuit 40 is arranged to measure a capacitance which is associated with the display elements and which is dependent on the LC display element capacitances rather than measuring an LC display element capacitance directly. The capacitor lines 22 or the common electrode 24 are utilised for this purpose. As actual picture elements in the array display area are used rather than dummy picture elements, the measurement consequently takes into account the different drive conditions experienced by the picture elements, for example resulting from different video images being displayed over time, without requiring the generation of any special drive signals. The result of the measurement will be representative of the average drive conditions experienced by the picture elements taking into account also variations over the area of the array due to variations in alignments or dielectric thicknesses.

Referring to FIG. 7, the circuit configuration of a first embodiment of AMLCD in accordance with the invention is shown in which the capacitor lines 22 are used to provide the input to the oscillator circuit 40. The device is in most respects similar to that of FIG. 1. The capacitor lines 22 are all interconnected together at their one ends and, again, connected to the low impedance, reference potential source 23, except in this case via a switch, 50, corresponding to the switch S₂ in the FIG. 3 circuit arrangement. The lines 22 are connected also to the input of the oscillator circuit 40 via the coupling capacitor C_{C}, as in the FIG. 3 circuit arrangement.

When a measurement is being made, the switch 50 connecting the lines 22 to the low impedance source 23 is opened so that the capacitance of the display elements 21 becomes one of the parameters determining the frequency of oscillation of the circuit 40.

The polarity of drive voltages applied to the LC display elements 21 usually needs to be inverted periodically. Conventionally, this inversion may be every frame. However, in some schemes, for example a line inversion drive scheme in which the polarity of drive voltages is inverted for successive rows, the nature of the addressing of the picture elements may be such that half the display elements are addressed with a positive drive voltage and half the display elements are addressed with a negative drive voltage. If it is necessary to separately measure the response of the LC display elements 21 to these two drive polarities then it will be necessary to provide separate connections to display elements receiving positive and negative drive voltages. For example, if the array is addressed using a row inversion drive scheme in which alternate rows of picture elements are addressed with opposite polarities then the capacitor lines 22 of the alternate rows could be joined to common points and a switching arrangement used to connect the elements of one of the two sets of rows to the input of the oscillator. This would allow a capacitance measurement to be made on display elements receiving positive drive voltages and display elements receiving negative drive voltages within the same frame period.

As mentioned earlier the finite response speed of the liquid crystal molecules means that when the drive voltage applied to the liquid crystal is changed it takes some time for the liquid crystal to respond to this change. In the measuring scheme indicated previously (FIG. 4) the capacitance measurement is made shortly before the voltage across the LC display element 21 is inverted in order to ensure that the liquid crystal had been given time to react to any change in voltage. A similar approach can be implemented when the capacitance associated with the display elements is being measured by using the coupling arrangement in the alternative device circuit illustrated in FIG. 8. In this case a capacitor line selector circuit 60 selectively controlling a group of change-over switches 61 is used to determine which of the capacitor lines 22, or groups of capacitor lines, is connected to the input of the oscillator circuit 40 at any one time. The switching of the capacitor line selector circuit 60 can be synchronised with the operation of the row drive circuit 28 of the device to ensure that the capacitance measurements are made at an appropriate time within the addressing cycle of each row of picture elements.

The description above indicates the general manner in which an oscillator circuit is used to measure the capacitance of LC display elements in order for example to determine their response to the applied drive waveforms. A specific example of an oscillator circuit 40 has been described (FIG. 3) which is particularly simple and suitable for integration onto the first substrate of the AMLCD using thin film transistors. Other types of oscillator circuit could also be used in a similar way as long as the changing capacitance of the LC display elements is one of the parameters which determines their frequency of oscillation. In the examples given it is convenient to operate the oscillator circuit 40 continuously although it would clearly be possible to enable the oscillator circuit only during a measurement period in order to minimise the power consumption of the AMLCD. In the embodiments of FIGS. 7 and 8 the coupling of the input of the oscillator circuit to the LC display elements is achieved by making use of the storage capacitors which are normally connected in parallel with the LC display elements and by adding a further coupling capacitor, C_{C}. There will also be other methods by which the capacitance of the LC elements 21 could be coupled to the input of the oscillator, as will be apparent to persons skilled in the art. One such other method would be to use the common electrode 24 of the AMLCD to provide this connection rather than the capacitor lines 22.

FIG. 9 shows the circuit configuration of a second embodiment of AMLCD according to the invention using the common electrode 24 to provide input to the oscillator circuit 40. This example also uses an alternative configuration for the storage capacitor in which separate capacitor lines are not provided and instead the sides of the storage capacitors 20 remote from the picture element electrodes 15 are connected to a row address conductor 14 of an adjacent row of picture elements 12.

The common electrode 24 is connected to a common electrode drive circuit 70 via a switch 72 which corresponds functionally with the switch S₂ in the FIG. 3 circuit arrangement and to which the measure enable waveform M is applied. The common electrode 24 is connected also to the input of the oscillator circuit 40 via the coupling capacitor C_{C}. In other respects, the circuitry and the operation of the adjustment means is similar to that of the previous embodiment.

In the above example embodiments, a single oscillator circuit is used to measure the capacitance of different LC display elements 21. This is important when a direct comparison of the capacitance of the elements is required because the measured frequency will depend on the characteristics of the oscillator circuit. However, there may be circumstances where it is preferable to provide more than one oscillator circuit. Separate oscillator circuits could be provided for different sets of LC display elements. For example, one oscillator circuit may be provided for each row of picture elements in the case of the embodiment of FIG. 8.

The measurement of the capacitance of the LC display elements can be used to control the drive waveforms of the AMLCD as described previously, for example to provide automatic adjustment of the drive voltages applied to the picture elements, specifically the dc voltage appearing across the liquid crystal and the peak to peak drive voltage which determines the greyscale performance of the device. In principle the approach can be extended to the automatic adjustment of any aspect of the display drive waveforms which cause the response of the liquid crystal to change. For example the row select (gating) or non-select voltages of the waveform applied by the drive circuit 28 to the row address conductors 14 could be adjusted by detecting whether a small change in these voltages has any effect on the capacitance (and therefore on the grey-level) of the display elements within the array. As another example, in order to minimise the power consumption of the AMLCD, the addressing frequency could be reduced to a level determined by detecting when a further reduction in frequency would result in unacceptable discharge of the display elements during the frame period. The discharge of the display element voltage could be detected via the change in the capacitance of the liquid crystal. This measurement technique could also be used to determine the switching speed of the liquid crystal and to adjust a correction algorithm.

Some of these measurements and adjustments of the drive waveform parameters could be carried out at extended intervals, for example, each time that the AMLCD is turned on. Ideally, the values of the parameters would be stored so that it was only necessary to make small adjustments to the drive parameters when the device is turned on rather than having to establish the parameters from some default setting. These measurements might require some specific test waveforms or test patterns to be applied to the AMLCD or the LC display elements 21 during the test. For example signals representing different grey levels might be applied, the drive frequency might be altered, or some other aspect of the drive conditions varied.

Other measurements might be performed during the operation of the AMLCD. For example, adjustment of the drive voltages to correct for the effect of temperature variations might be carried out periodically while the device is operating.

It may be advantageous to integrate a number of separate LC display element capacitance measurement circuits on the devices substrate. These could control different aspects of the drive waveforms applied to the array and they could be designed and operated in a way which is best suited to their function. For example LC display elements 21 within the array could be used to determine the dc voltage applied to the array. One of the parameters which determines the dc voltage is the offset voltage which occurs within the picture elements 12 when the TFTs 18 turn off. It is therefore advantageous to adjust the dc voltage by measuring the capacitance of the display elements within the array.

The proposed form of adjusting means is most relevant to AMLCDs in which the drive circuits are integrated onto the active substrate of the device. However, this adjustment means and measurement technique could also be implemented using external circuitry, for example within the crystalline silicon drive ICs of an AMLCD which does not have integrated drive circuits.

From reading the present disclosure, other modifications will be apparent to persons skilled in the art. Such modifications may involve other features which are already known in the field of active matrix liquid crystal display devices and component parts therefore and which may be used instead of or in addition to features already described herein.

1. An active matrix liquid crystal display device having in a display area an array of picture elements operable to produce a display image, each picture element comprising a picture element electrode which together with an opposing, common, electrode defines a liquid crystal display element, and a storage capacitor connected to the picture element electrode, the device including adjustment means for adjusting drive signals applied to the picture elements in accordance with changes in the liquid crystal capacitance wherein the adjustment means comprises an oscillator circuit which is coupled to a plurality of picture elements in the array and whose frequency of oscillation provides a measure of a capacitance associated with the plurality of picture elements and dependent on the capacitance of their respective liquid crystal display elements.

2. A device according to claim 1, wherein respective first electrodes of the storage capacitors of the plurality of picture elements are connected together and wherein the adjustment means is arranged to measure the capacitance of the connected first electrodes of the storage capacitors.

3. A device according to claim 1, wherein the storage capacitors are connected between their respective picture element electrodes and a connection line common to the storage capacitors of the plurality of picture elements and wherein the adjustment means is arranged to measure the capacitance associated with the connection line.

4. A device according to claim 3, wherein the storage capacitor connection line is connected to switch means that is selectively operable to couple the connection line to a source of predetermined potential or to the oscillator circuit to enable the adjustment means to perform a measuring operation.

5. A device according to claim 1, wherein the adjustment means is arranged to measure the capacitance of the common electrode.

6. A device according to claim 5, wherein the common electrode is connected to switch means that is selectively operable to couple the common electrode to a source of predetermined potential or to the oscillator circuit to enable the adjustment means to perform a measuring operation.

7. A device according to claim 1, wherein the oscillator circuit of the adjustment means is coupled to all the picture elements in the array with the measurement provided thereby being dependent on a capacitance associated with the display elements of all the picture elements in the array.

8. A device according to claim 1, wherein the oscillator circuit of the adjustment means comprises thin film circuitry integrated on a substrate of the device which carries the picture element electrodes.

9. A device according to claim 1, wherein an input of the oscillator circuit of the adjustment means is coupled to the plurality of picture elements via a coupling circuit comprising a capacitor.
